(19) United States
(12) Patent Application Publication
(10) Pub. No.: US 2026/0058424 A1
(43) Pub. Date: Feb. 26, 2026

(54) REMOVABLE CHARGING PORT SYSTEM FOR A VEHICLE

(71) Applicant: Ford Global Technologies, LLC, Dearborn, MI (US)

(72) Inventors: Sebastien Raymond Brunereau, Mexico City (MX); Alejandro Garnica Izzo, Mexico City (MX); Bernardo Quintero, Atizapán de Zaragoza (MX); Carlos Buendia Moreno, Mexico City (MX)

(73) Assignee: Ford Global Technologies, LLC, Dearborn, MI (US)

(21) Appl. No.: 18/809,499

(22) Filed: Aug. 20, 2024

(51) Int. Cl. H01R 31/06; B60R 16/033; H01R 13/66; H02J 7/00; H02J 50/00; H02J 50/10

(52) U.S. Cl. CPC H01R 31/065; B60R 16/033; H01R 13/6675; H02J 7/0044; H02J 50/005; H02J 50/10

(57) ABSTRACT

A charging port system for a vehicle includes a housing configured to be installed on a component in the vehicle. An input port is configured to be coupled to a vehicle charging port to receive electrical power. First and second output ports are provided on the housing. The second output port has a different shape than the first output port. A wireless charger is provided on the housing. The system also includes a net for securing devices, extendable arms for adjustable positioning, and an internal battery to ensure power availability and optimal power distribution, even when the vehicle is turned off.

### FIELD OF THE DISCLOSURE

The present disclosure generally relates to motor vehicle charging ports, and more particularly relates to a removable charging port system for charging rechargeable electronic devices in a vehicle with multiple outlet ports.

### BACKGROUND OF THE DISCLOSURE

Motor vehicle are commonly equipped with one or more electrically powered charging ports for charging and powering portable electronic devices onboard the vehicle. For example, vehicles typically include one or more USB charging ports configured to receive USB connectors plugged into portable electronic devices that have rechargeable batteries to thereby charge and/or operate the portable electronic device. Motor vehicles are also configured with wireless chargers. It may be desirable to provide for a charging port system for a vehicle that provides for a multiple-port charging system that may be installed on a vehicle to offer a variety of charging options.

### SUMMARY OF THE DISCLOSURE

According to a first aspect of the present disclosure, a charging port system for a vehicle includes a housing configured to be installed on a component in the vehicle. An input port is configured to be coupled to a vehicle charging port to receive electrical power. First and second output ports are provided on the housing. The second output port has a different shape than the first output port. A wireless charger is provided on the housing.

Embodiments of the first aspect of the present disclosure can include any one or a combination of the following features:
the housing is configured to connect onto a center console in the vehicle;
the housing is configured to connect onto a rear wall of the center console;
the housing is configured to removably connect via one or more protrusions matingly engaged with the center console;
a device holder located proximate to the wireless charger;
the device holder is moveable between a deployed and stowed position;
the first output port comprises a USB-A port, and the second output port comprises a USB-C port;
the wireless charger comprises a wireless inductive charger;
one or more light devices provided on the housing;
a battery pack; and
a retainer net connected to the housing with a plurality of attachment features.

According to a second aspect of the present disclosure, a removable charging port system for a vehicle includes a housing having a shape and size configured to be removably installed on a rear wall of a center console in the vehicle. An input port is configured to be coupled to a vehicle charging port to receive electrical power. First and second output ports are provided on the housing. The second output port has a different shape than the first output port. A wireless charger is provided on the housing.

Embodiments of the second aspect of the present disclosure can include any one or a combination of the following features:
the housing is configured to connect via one or more protrusions matingly engaged with the center console;
a device holder located proximate to the wireless charger;
the wireless holder is moveable between a deployed and stowed position;
the first output port comprises a USB-A port, and the second output port comprises a USB-C port;
the wireless charger comprises a wireless inductive charger;
one or more light devices provided on the housing;
a battery pack; and
a net connected to the housing with a plurality of attachment features.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a rear side perspective view of a cabin interior of a motor vehicle having a removable charging port system assembled on a rear wall of a center console, according to one embodiment;

FIG. 2 is an enlarged perspective view of the rear portion of the center console having the removable charging port system and a chargeable device attached to the rear wall of the center console;

FIG. 3 is an exploded view of the removable charging port system removed from the rear wall of the center console;

FIG. 4 is a rear perspective view of the removable charging port system;

FIG. 4A is an exploded rear perspective view of the removable charging port system; and

FIG. 5 is a perspective view of the rear end of the center console having a removable charging port system further configured with a retainer net.

### DETAILED DESCRIPTION OF PREFERRED EMBODIMENTS

Reference will now be made in detail to the present preferred embodiments of the disclosure, examples of which are illustrated in the accompanying drawings. Wherever possible, the same reference numerals will be used throughout the drawings to refer to the same or like parts. In the drawings, the depicted structural elements are not to scale and certain components are enlarged relative to the other components for purposes of emphasis and understanding.

As required, detailed embodiments of the present disclosure are disclosed herein; however, it is to be understood that the disclosed embodiments are merely exemplary of the disclosure that may be embodied in various and alternative forms. The figures are not necessarily to a detailed design; some schematics may be exaggerated or minimized to show function overview. Therefore, specific structural and functional details disclosed herein are not to be interpreted as limiting, but merely as a representative basis for teaching one skilled in the art to variously employ the present disclosure.

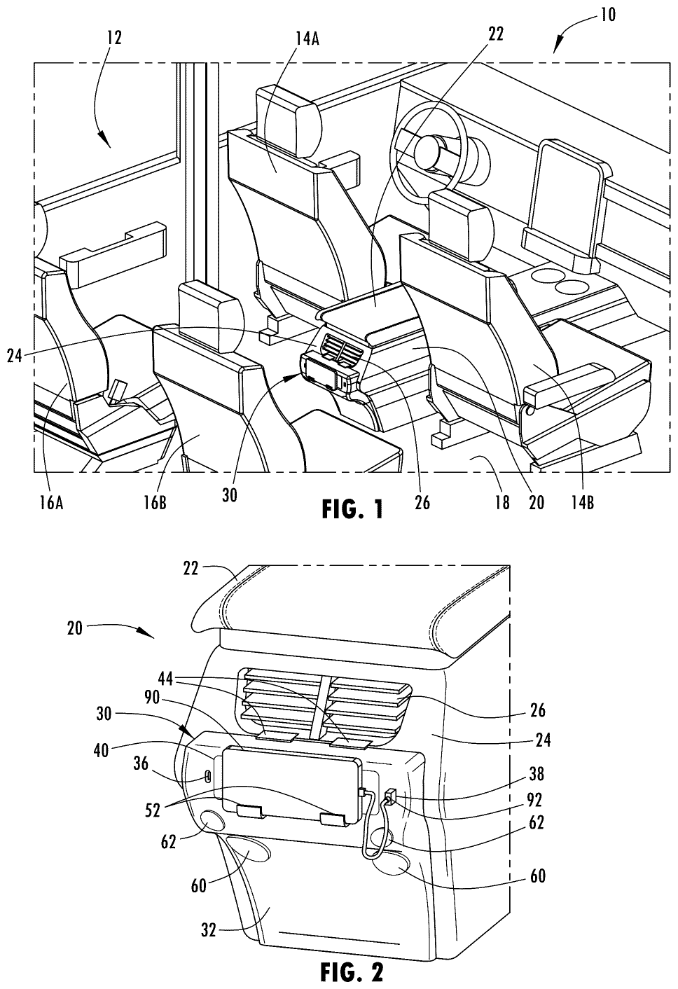

For purposes of description herein, the terms “upper,” “lower,” “right,” “left,” “rear,” “front,” “vertical,” “horizontal,” and derivatives thereof shall relate to the concepts as oriented in FIG. 1. However, it is to be understood that the concepts may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The present illustrated embodiments reside primarily in combinations of method steps and apparatus components related to a removable charging port system for a vehicle. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

As used herein, the term “and/or,” when used in a list of two or more items, means that any one of the listed items can be employed by itself, or any combination of two or more of the listed items, can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

Referring to FIG. 1, a motor vehicle 10 is generally illustrated configured with passenger seating for transporting one or more passengers including a driver of the motor vehicle 10 and for further transporting one or more passengers and items including portable electronic devices on board the motor vehicle 10. The motor vehicle 10 generally has a vehicle body that generally defines a cabin interior 12 which may also be referred to as a passenger compartment. The cabin interior 12 may contain various features and trim components. The cabin interior 12 is shown having an arrangement of front row passenger seats including a first seat assembly 14A configured to seat a driver and a second seat assembly 14B configured to seat a passenger. The first and second seat assemblies 14A and 14B may be configured as captain seats, for example, laterally spaced apart and separated by a space that includes a center console 20 that may be configured to receive a removable charging port system 30 on a rear wall 24 at the rear end of the center console 20.

The motor vehicle 10 illustrated in the example also includes additional seating such as a second row of seating including third and fourth seat assemblies 16A and 16B which may be spaced apart or connected with a middle seat. Passengers seated in the third and fourth seat assemblies 16A and 16B are presented in close proximity to the rear end of the center console 20 such that the passengers may interact with and utilize the removable charging port system 30 as described herein. The motor vehicle 10 may include additional rows of seating as is common with large SUVs, vans or buses, and additional center consoles which may be configured to receive a removable charging port system 30 may be included in the second and further rearward rows of seating. It should be appreciated that the motor vehicle 10 may be a motor vehicle such as a wheeled car, truck, SUV, van or bus, for example, or an airplane, train, boat or other vehicle capable of transporting one or more passengers and items.

The cabin interior 12 is configured with the center console 20 supported on a floor 18 located in the space between the driver's seat assembly 14A and the passenger second seat assembly 14B in the front first row of seating. It should be appreciated that the center console 20 and additional center consoles may be located at various locations within the motor vehicle 10, such as between other adjacent seat assemblies. For example, a center console may be located in a space between the third and fourth seat assemblies 16A and 16B.

The center console 20 is shown generally having a housing supported on the underlying floor 18 in the cabin interior 12. The center console 20 has lateral side walls, a front wall and the rear wall 24 that may define a storage compartment which may have an open top end that is shown closed with a lid 22 that also is configured as an arm rest 22 that may be pivoted to an open position to expose the underlying storage compartment or in a closed position to cover the storage compartment and to also serve as an armrest for the front row seated driver and passenger. In the example shown, the center console 20 has a generally rectangular configuration and has the rear wall 24 equipped with air vents 26 located on an upper portion thereof.

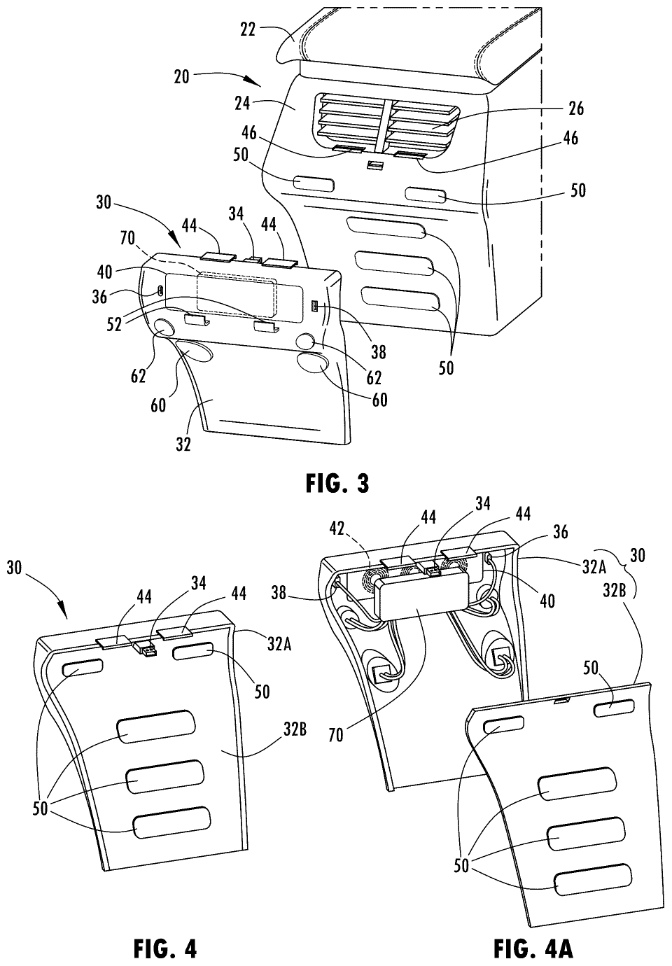

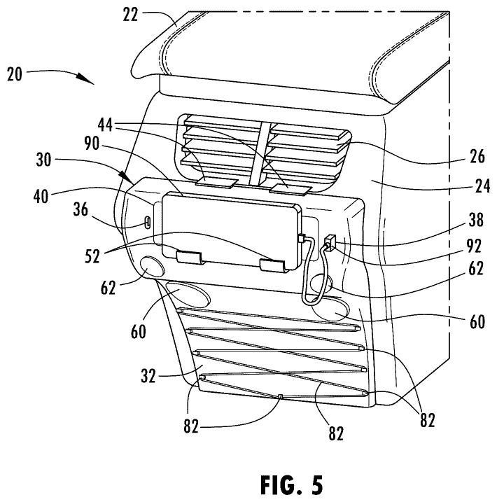

The removable charging port system 30 is illustrated in FIGS. 2 through 4A generally having a housing 32 that may be connected onto the rear wall 24 of the center console 20 and may further be removable from the rear wall 24 of the center console 20. The housing 32 generally has a shape and size configured to conform with and be installed or assembled onto the rear wall 24 and fastened and adhered to the rear wall 24 and may be removed from the rear wall 24 by unfastening and freed from the housing 32. The center console 20 includes a pair of horizontal slots 46 located at the lower end of the air vents 26. The housing 32 has a pair of horizontal protrusions 44 on the upper end that are configured as elongated connectors to extend into the pair of horizontal slots 46 and connect to the rear wall 24 of the center console 20 to retain the upper portion of the housing 32 connected to the rear wall 24 of the center console 20. To further retain lower portions of the housing 32 stably onto the rear wall 24 of the center console 20, a plurality of adhesive stickers 50 are shown at different locations on the rear wall 24 for adhering to the underside of the housing 32. The adhesive stickers 50 adhere the housing 32 to the rear wall 24 during normal vehicle use and may unstick to release the housing 32 from the rear wall 24 with force to remove the charging port system 30 from the center console 20.

The center console 20 is illustrated configured with an output port 48 which may include a USB port according to one example for providing data and power to communicate with and charge one or more electronic devices. The output port 48 is shown in one example located near a central upper portion on the rear wall 24. The removable charging port system 30 has an input port 34 on the inside wall that is configured with a shape, size and alignment to connect with the output port 48 at an upper end of the housing 32 when the housing 32 is attached to the rear wall 24 of the center console 20. As such, the removable charging port system 30 receives electrical power such as 12-volt DC power via the USB connection from the vehicle battery and may communicate with the motor vehicle 10 including control circuitry and accessories associated with the motor vehicle 10.

The removable charging port system 30 is configured to include a first output port 36 on the outside wall of the housing 32 and a second output port 38 on the outside wall of the housing 32, wherein the second output port 38 has a different shape or configuration than the first output port 36. The first and second output ports 36 and 38 are shown in one example spaced apart on left and right sides. According to one example, the first output port 36 may be configured as a USB-A port and the second output port 38 may be configured as a USB-C port. As such, the first and second input ports 36 and 38 are configured with different sizes and shaped connectors and may connect with different types of power and/or data communication connectors associated with rechargeable electronic devices, such as phones, tablets, computers, etc.

The removable charging port system 30 is further configured to include a wireless charger 40. The wireless charger 40 is generally located in a position proximate to the inner surface of the housing 32 and configured to electrically charge a chargeable electronic device that may be held on the outer surface of the housing 32 via a device holder such as a pair of folding support arms 52. The wireless charger 40 is configured as a wireless inductive charger which is further illustrated in FIG. 4A having one or more inductive charging coils 42. The inductive charging coils 42 are configured to generate an inductive field due to an electrical current to wirelessly transmit electrical power to one or more inductive coils located in a chargeable device to perform wireless charging and/or powering of the chargeable device. As a result, the removable charging port system 30 advantageously is an add-on system that provides for a multi-port charger that offers first and second output ports 36 and 38 and wireless charging via the wireless charger 40. This allows a user to convert the charging features of a single output port presented on the rear wall 24 of the center console 20 into a plurality of charging ports 36, 38 and 40 for use by one or more passengers in the motor vehicle 10, such as the passengers seated in the rear row of seating.

The removable charging port system 30 may further include a supplemental power source in the form of a rechargeable battery pack 70 which may include one or more battery cells to provide a reserve electrical power source. The first and second output ports 36 and 38 and the inductive charger 40 may supply electrical power such as from a vehicle electrical battery and/or the battery pack 70 for use with the first and second ports 36 and 38 and the inductive charger 40. The battery pack 70 may be continuously charged by the vehicle battery and, in turn, may supply power to the first and second ports 36 and 38 and the inductive charger 40.

The removable charging port system 30 also includes a pair of lighting devices 60 which are shown located on opposite lateral sides of the housing 32 and arranged to illuminate the cabin interior near the floor vehicle rearward of the center console 20 and on left and right sides. The lighting devices 60 may each include one or more light emitting diodes (LEDs), such as RGB LEDs for example. The lighting devices 60 may be controlled via user input switches 62 such as mechanical push button switches or capacitive switches to turn the corresponding lighting devices 60 on and off and to control intensity and color of the light beams, for example.

Referring to FIG. 4, the rear portion of the center console 20 is illustrated having a removable charging port system 30 further configured with a retainer net 80 that is configured to hold one or more items. The retainer net 80 is shown in one example connected to the lower rear portion of the housing 32 with a plurality of net hooks 82 which serve as attachment features. The retainer net 80 may be elastic and therefore deformable expandable with memory to allow for ease of insertion, removal and retention of one or more items within the retainer net 80 held against the rear wall 24 of the center console 20.

Accordingly, the removable charging port system 30 advantageously provides for an add-on multi-port charging device that offers additional charging ports for use on a motor vehicle 10 by providing a first output port, a second output port and a wireless charging port to meet the needs of users having various rechargeable electronic devices with various connectors.

It is to be understood that variations and modifications can be made on the aforementioned structure without departing from the concepts of the present disclosure, and further it is to be understood that such concepts are intended to be covered by the following claims unless these claims by their language expressly state otherwise.

What is claimed is:

1. A charging port system for a vehicle, the charging port system comprising:
a housing configured to be installed on a component in the vehicle;
an input port configured to be coupled to a vehicle charging port to receive electrical power;
a first output port provided on the housing;
a second output port provided on the housing, wherein the second output port has a different shape than the first output port; and
a wireless charger provided on the housing.

2. The charging port system of claim 1, wherein the housing is configured to connect onto a center console in the vehicle.

3. The charging port system of claim 2, wherein the housing is configured to connect onto a rear wall of the center console.

4. The charging port system of claim 3, wherein the housing is configured to removably connect via one or more protrusions matingly engaged with the center console.

5. The charging port system of claim 1, further comprising a device holder located proximate to the wireless charger.

6. The charging port system of claim 5, wherein the device holder is moveable between a deployed and stowed position.

7. The charging port system of claim 1, wherein the first output port comprises a USB-A port, and the second output port comprises a USB-C port.

8. The charging port system of claim 1, wherein the wireless charger comprises a wireless inductive charger.

9. The charging port system of claim 1, further comprising one or more light devices provided on the housing.

10. The charging port system of claim 1, further comprising a battery pack.

11. The charging port system of claim 1, further comprising a retainer net connected to the housing with a plurality of attachment features.

12. A removable charging port system for a vehicle, the charging port system comprising:
a housing having a shape and size configured to be removably installed on a rear wall of a center console in the vehicle;
an input port configured to be coupled to a vehicle charging port to receive electrical power;
a first output port provided on the housing;
a second output port provided on the housing, wherein the second output port has a different shape than the first output port; and
a wireless charger provided on the housing.

13. The charging port system of claim 12, wherein the housing is configured to connect via one or more protrusions matingly engaged with the center console.

14. The charging port system of claim 12, further comprising a device holder located proximate to the wireless charger.

15. The charging port system of claim 14, wherein the wireless holder is moveable between a deployed and stowed position.

16. The charging port system of claim 12, wherein the first output port comprises a USB-A port, and the second output port comprises a USB-C port.

17. The charging port system of claim 12, wherein the wireless charger comprises a wireless inductive charger.

18. The charging port system of claim 12, further comprising one or more light devices provided on the housing.

19. The charging port system of claim 12, further comprising a battery pack.

20. The charging port system of claim 12, further comprising a net connected to the housing with a plurality of attachment features.
